(19) United States
(12) Patent Application Publication
(10) Pub. No.: US 2025/0330753 A1
(43) Pub. Date: Oct. 23, 2025

(54) LOUDSPEAKER TRANSDUCERS

(71) Applicant: Polk Audio, LLC, Carlsbad, CA (US)

(72) Inventor: Sean O'Brien, Carlsbad, CA (US)

(21) Appl. No.: 18/870,557

(22) PCT Filed: May 30, 2023
(86) PCT No.: PCT/EP2023/064440

§ 371 Date: Nov. 29, 2024

Related U.S. Application Data
(63) Continuation of application No. 17/828,792, filed on May 31, 2022, now Pat. No. 12,256,208.

(51) Int. Cl. H04R 9/06; H04R 7/12; H04R 7/18; H04R 9/02; H04R 9/04; H04R 31/00

(52) U.S. Cl. CPC H04R 9/06; H04R 7/12; H04R 7/18; H04R 9/025; H04R 9/04; H04R 31/003; H04R 31/006; H04R 2400/11

(57) ABSTRACT

The present disclosure relates to a loudspeaker transducer comprising a diaphragm (112), a frame (120), an inner suspensions element (118) and an outer suspension element (110). The diaphragm (112) comprises a portion turning inwards (102) towards the frame (120). The outer suspension element (110) is located closer than the inner suspension element (118) to the main opening of the frame through which the loudspeaker transducer radiates sound. The inner suspension element (118) is connected to the frame (120) and the inward turning portion (102). The inner suspension element (118) is connected to the inward turning portion (102) at an outer end (203) of the diaphragm.

### TECHNICAL FIELD

The present disclosure concerns loudspeaker transducers. More particularly, but not exclusively, some implementations of the present disclosure concern loudspeaker transducers comprising a diaphragm with an inward turning portion.

### DESCRIPTION OF THE RELATED TECHNOLOGY

A conventional loudspeaker transducer generates sound by driving a diaphragm up and down along a central axis, while the diaphragm is supported by one or more suspension elements that act to reduce vibrations/movement in other directions. A typical loudspeaker transducer has a voice coil which is affixed to the center of a frusto-conical diaphragm. The diaphragm (or ‘cone’ or ‘sound radiator’) is attached at its outermost edge to the inner edge of an outer suspension element (or ‘surround’). The outer suspension element is attached at its outer edge to a rigid frame (or ‘basket’). The voice coil is attached to the diaphragm and also to an inner suspension element (typically called a ‘spider’) which acts to keep the voice coil centered on its axis as it oscillates. The outer edge of the spider is connected to the rigid frame. The frame also typically houses a magnet structure which is fixed centrally in relation to the rigid frame. The magnet structure and the voice coil are commonly referred to as the motor. The diaphragm and voice coil are elastically supported by the frame so that they are able to move back and forth along the central axis while the frame and magnet structure remain fixed in place. A dust cap is commonly fixed above the hole in the center of the diaphragm to stop dust from entering into the magnet structure. The displacement of the diaphragm from a neutral position is known as its excursion. In loudspeaker transducers that produce lower frequencies, a relatively large excursion is required, in comparison to the typical excursions of higher frequency loudspeaker transducers, for the required frequencies of sound waves to be produced at a particular desired acoustic output level. A loudspeaker transducer should provide sufficient space around the diaphragm in order for the required peak-to-peak excursion of the diaphragm to be possible without colliding with other parts of the loudspeaker transducer. Loudspeaker transducers that produce low frequencies (‘woofers’ or ‘subwoofers’) are often required to be fitted into sound bars and other enclosures that require them to have a shallower depth than they would ordinarily. Loudspeaker transducers with typical frusto-conical cones having the required space for excursion are therefore limited as to how much the depth of the loudspeaker transducer can be reduced before sound quality will be impacted. There is therefore a need for improved loudspeaker transducer designs, particularly where overall speaker dimensions are limited.

The present disclosure seeks to mitigate the above-mentioned problems. Alternatively or additionally, the present disclosure seeks to provide improved loudspeaker transducers.

### SUMMARY

Certain example aspects of the present disclosure are summarized below for illustrative purposes. The disclosure is not limited to the specific implementations recited herein. Aspects of the disclosure may include several novel features, no single one of which is solely responsible for its desirable attributes.

A first aspect of the present disclosure relates to a loudspeaker transducer comprising a diaphragm, a frame, an inner suspension element and an outer suspension element, wherein: the diaphragm comprises a portion turning inwards towards the frame, the outer suspension element is located closer than the inner suspension element to the main opening of the frame through which the loudspeaker radiates sound, the inner suspension element is connected to the frame and the inward turning portion, and the inner suspension element is connected to the inward turning portion at an outer end of the diaphragm.

In embodiments, a length of the inward turning portion is dependent upon a desired excursion parameter of the loudspeaker transducer.

In embodiments, a length of the inward turning portion is dependent upon a desired depth of the loudspeaker transducer.

In embodiments, the inner suspension element is continuously connected to the inward turning portion along an entire outer end of the diaphragm. In alternative embodiments, the inner suspension element is discontinuously connected to the inward turning portion at one or more parts of an outer end of the diaphragm.

In embodiments, the loudspeaker transducer comprises a voice coil, wherein the voice coil is not connected to the inner suspension element.

In embodiments, the loudspeaker transducer comprises a voice coil, wherein the voice coil is connected to an inner end of the diaphragm.

In embodiments, the diaphragm comprises an inner portion, and the inner portion comprises an inner end of the diaphragm.

In embodiments, the inner portion turns inwards towards the frame.

In embodiments, the inner portion is substantially parallel to the inward turning portion.

In embodiments, the loudspeaker transducer comprises a magnet structure, wherein the inward turning portion overlaps outside a perimeter of the magnet structure with at least part of the height of the magnet structure.

In embodiments, the diaphragm comprises a further portion.

In embodiments, the loudspeaker transducer comprises a magnet structure, wherein the further portion is substantially parallel to a top surface of the magnet structure.

In embodiments, the inward turning portion is substantially perpendicular to the further portion.

In embodiments, the inward turning portion is connected to the further portion at an outer edge of the diaphragm.

In embodiments, the outer suspension element is connected to the frame and the diaphragm.

In embodiments, the outer suspension element is connected to the frame and the diaphragm, and the outer suspension element is connected to an outer edge of the further portion of the diaphragm.

In embodiments, the wherein the inner suspension element comprises a surface with at least one perforation.

In embodiments, the further portion comprises an annulus.

In embodiments, the further portion comprises one or more corrugations. In embodiments, at least one of the one or more corrugations is v-shaped.

In embodiments, the further portion of the diaphragm is detachably connected to the inward turning portion of the diaphragm at a shoulder of the diaphragm.

In embodiments, the inward turning portion comprises a cylindrical hollow tube.

In embodiments, the inward turning portion comprises one or more holes. In embodiments, the inward turning portion comprises a first set of holes and a second set of holes, the second set of holes being larger than the first set of holes.

A second aspect of the present disclosure relates to a method of manufacturing a loudspeaker transducer comprising a diaphragm, a frame, an inner suspension element and an outer suspension element, the method comprising: forming the diaphragm with a portion turning inwards towards the frame, and attaching the inner suspension element to the frame and the inward turning portion at an outer end of the diaphragm. The inner suspension element is attached to the frame and the diaphragm such that it is further away than the outer suspension element to the main opening of the frame through which the loudspeaker transducer radiates sound.

A third aspect of the present disclosure relates to a method of manufacturing a loudspeaker transducer, the method comprising: forming a diaphragm; forming a first frame part; forming a suspension element; forming a second frame part; attaching a suspension element to the first frame part; attaching the diaphragm to the suspension element, wherein the diaphragm comprises an inward turning portion which turns inwards towards the first frame part and the suspension element attaches to the inward portion at an outer edge of the diaphragm; and attaching the second frame part to the first frame part.

In embodiments, the method of manufacturing a loudspeaker transducer comprises: forming a further portion; forming the inward turning portion; and attaching the further portion to the inward turning portion.

In embodiments, the method of manufacturing a loudspeaker transducer comprises: forming a further suspension element; attaching the further suspension element to the second frame part; and attaching the further suspension element to the diaphragm.

A fourth aspect of the present disclosure relates to a loudspeaker transducer comprising: a frame; a magnet structure mounted to the frame; a voice coil configured to operate with the magnet structure as a motor; a diaphragm having an inner portion and an outer portion; an inner coupler that couples the voice coil to the inner portion of the diaphragm; an outer coupler that extends from an outer portion of the diaphragm; a first suspension element coupled between the frame the outer coupler; and a second suspension element coupled between the frame and the outer portion of the diaphragm.

In embodiments, the inner coupler and the outer coupler are substantially parallel.

In embodiments, the outer coupler extends rearward along a direction that is substantially parallel to a longitudinal axis of the transducer.

In embodiments, the first suspension element is disposed directly rearward of the second suspension element.

In embodiments, the first suspension element and the second suspension element are disposed laterally outward of the magnet structure.

In embodiments, the first suspension element and the second suspension element are disposed laterally outward of the diaphragm.

In embodiments, the outer coupler and the diaphragm are integrally formed. In alternative embodiments, the outer coupler and the diaphragm are separately formed components.

In embodiments, the diaphragm is generally perpendicular to a longitudinal axis of the loudspeaker transducer.

In embodiments, the diaphragm comprises corrugations.

In embodiments, the outer coupler includes holes.

It will of course be appreciated that features described in relation to one aspect of the present disclosure may be incorporated into other aspects of the present disclosure. For example, the method of the present disclosure may incorporate any of the features described with reference to the apparatus of the present disclosure and vice versa.

### BRIEF DESCRIPTION OF THE DRAWINGS

Certain embodiments will be discussed with reference to the following figures, wherein like reference numerals can refer to similar features throughout. It will be understood that elements illustrated in the figures are not necessarily drawn to scale, although the dimensions shown in the drawings form part of this disclosure. The figures are provided for illustrative purposes and the innovations are not limited to the specific implementations illustrated in the figures.

FIG. 1 is a perspective view of a loudspeaker transducer according to embodiments of the present disclosure;

FIG. 2 shows the loudspeaker transducer of FIG. 1 from a cross-sectional side view according to embodiments of the present disclosure;

FIG. 3 shows the loudspeaker transducer of FIG. 1 from a cross-sectional side view according to embodiments of the present disclosure;

FIG. 4 shows a plan view of the loudspeaker transducer of FIG. 1 according to embodiments of the present disclosure;

FIG. 5 shows a plan view of a loudspeaker transducer according to embodiments of the present disclosure;

FIG. 6 shows a cross-sectional side view of a loudspeaker transducer according to embodiments of the present disclosure;

FIG. 7 is a flow chart for methods of manufacture of a loudspeaker transducer according to embodiments of the present disclosure;

FIG. 8 is a flow chart for methods of manufacture of a loudspeaker transducer according to embodiments of the present disclosure.

FIG. 9 shows a cross-sectional side view of components of a loudspeaker transducer during assembly according to embodiments of the present disclosure;

FIG. 10 shows a cross-sectional side view of components of a loudspeaker transducer during assembly according to embodiments of the present disclosure;

FIG. 11 shows a cross-sectional side view of components of a loudspeaker transducer during assembly according to embodiments of the present disclosure;

FIG. 12 shows a cross-sectional side view of components of a loudspeaker transducer during assembly according to embodiments of the present disclosure;

FIG. 13 shows a cross-sectional side view of components of a loudspeaker transducer during assembly according to embodiments of the present disclosure;

FIG. 14 shows a perspective view of a loudspeaker transducer according to embodiments of the present invention;

FIG. 15 shows the loudspeaker transducer of FIG. 14 from a cross-sectional perspective view according to embodiments of the present disclosure;

FIG. 16 shows a perspective view of components of the loudspeaker transducer of FIG. 14 according to embodiments of the present disclosure;

FIG. 17 shows a cross-sectional perspective view of components of the loudspeaker transducer of FIG. 14 according to embodiments of the present disclosure;

FIG. 18a shows a perspective view from above of a component of the loudspeaker transducer of FIG. 14 according to embodiments of the present disclosure;

FIG. 18b shows a perspective view from below of the component of FIG. 18a according to embodiments of the present disclosure;

FIG. 19 shows a perspective view of a component of the loudspeaker transducer of FIG. 14 according to embodiments of the present disclosure; and

FIG. 20 shows a flow chart for methods of manufacture of a loudspeaker transducer according to embodiments of the present disclosure.

### DETAILED DESCRIPTION OF CERTAIN INVENTIVE EMBODIMENTS

The following description of certain embodiments presents various descriptions of specific embodiments. However, the innovations described herein can be embodied in a multitude of different ways, for example, as defined and covered by the claims. Moreover, it will be understood that certain embodiments can include more elements than illustrated in a drawing and/or a subset of the elements illustrated in a drawing. Further, some embodiments can incorporate any suitable combination of features from two or more drawings.

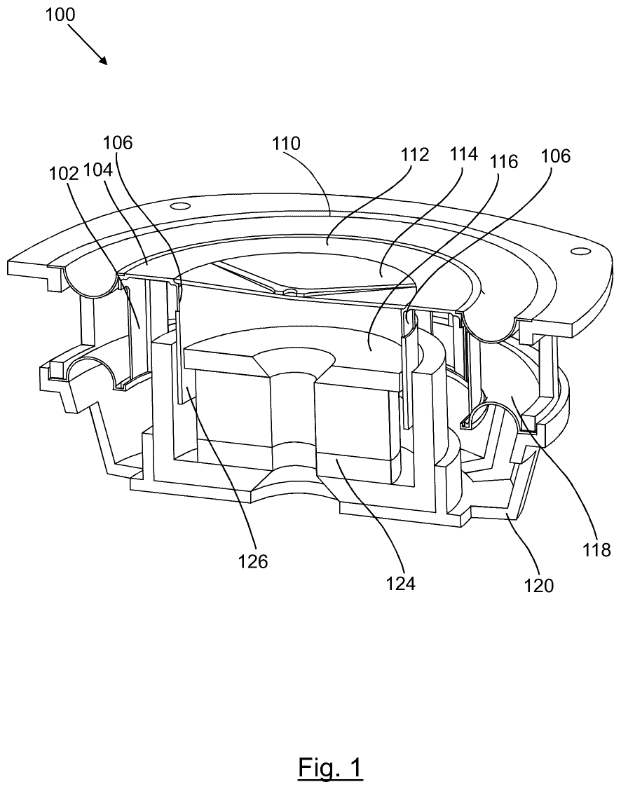

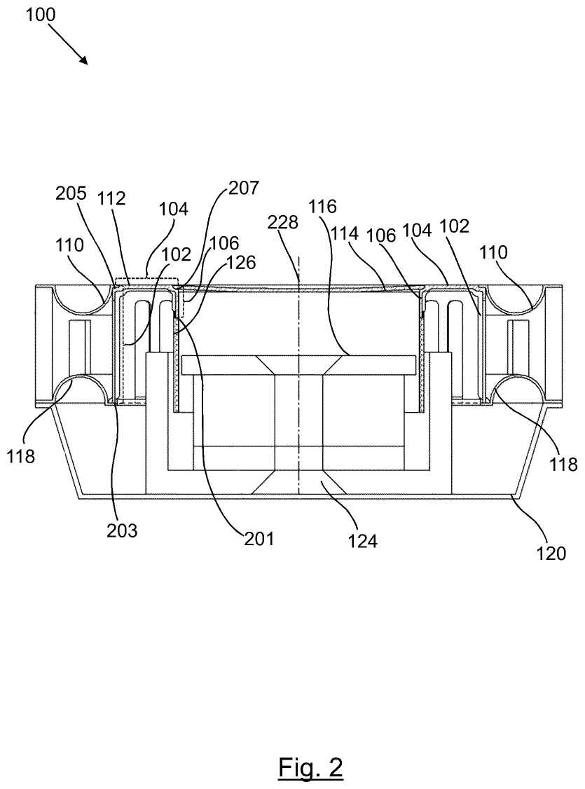

FIG. 1 shows a perspective view of a loudspeaker transducer 100 according to embodiments of the present disclosure. Loudspeaker transducer 100 comprises a frame 120, a magnet structure 124, a voice coil 126, a diaphragm 112, a first suspension element (e.g., sometimes referred to as an inner suspension element 118), a second suspension element (e.g., sometimes referred to as an outer suspension element 110), and a dust cap 114. FIG. 2 shows loudspeaker transducer 100 of FIG. 1 from a cross-sectional side view. Magnet structure 124 is attached to frame 120 centrally within loudspeaker transducer 100. A central axis 228 of magnet structure 124 is represented as a dashed line in FIG. 2. Diaphragm 112 is arranged such that it is centred on central axis 228 and attached to voice coil 126 such that voice coil 126 is centred on central axis 228. Accordingly, the central axis 228 can be a central axis of the transducer 100, the diaphragm 112, the voice coil 126, the first suspension element 118, the second suspension element 110, and/or various other components of the transducer 100 or any combinations thereof. The central axis can be a longitudinal axis 228. The loudspeaker transducer 100 can have a front side (e.g., which can be at the top of FIG. 2), and a back side (e.g., which can be at the bottom of FIG. 2). In some embodiments, the loudspeaker transducer 100 can be configured to radiate sound generally in a forward direction (e.g., which can be directed upward in FIG. 2), such as along a direction substantially parallel to the central axis 228. A rearward direction can be directed generally opposite of the direction that the transducer radiates sound, such as substantially parallel to the central axis (e.g., in a downward direction in FIG. 2). Although the loudspeaker transducer 100 can be positioned in various orientations, such as depending on how the loudspeaker transducer 100 is incorporated into a speaker or other system (e.g., front-firing, up-firing, down-firing speakers, etc.), this disclosure will generally refer to the loudspeaker transducer 100 in the up-firing orientation shown in FIG. 2, for example. Accordingly, references herein to the upper-facing direction can indicate the forward-facing direction (e.g., generally parallel to the central axis 228 in a direction from the magnet 124 structure towards the dust cover 114), and references to an above position can be a forward position (e.g., the dust cover 114 being above or forward of the magnet 124), etc. Similarly, references to a lower position can be a rearward position, etc. In embodiments, inner suspension element 118 has a semi-circular cross section which is convex in relation to frame 120. The inner suspension element 118 can be concave on its lower side, and can be convex on its upper side. Inner suspension element 118 has a connection on one side to frame 120 and on its other side to diaphragm 112. In embodiments, outer suspension element 110 has a semi-circular cross-section which is concave in relation to frame 120. The outer suspension element 110 can be convex on its lower side, and can be concave on its upper side. The inner suspension element 110 and the outer suspension element 118 can curve toward each other, for example as shown in FIG. 2, although various other configurations are possible. Outer suspension element 110 has a connection on one side to frame 120 and on its other side to diaphragm 112. Inner suspension element 118 and outer suspension element 110 are aligned in the direction of central axis 228. The first (inner) suspension element 118 can be disposed directly under (e.g., rearward) of the second suspension element 110. A footprint of the second suspension element 110 can at least partially overlap a footprint of the first suspension element 118 (e.g., when viewed along the direction of the main axis 228). The footprint of the second (outer) suspension element 110 can overlap a percentage of the footprint of the first suspension element 118 (e.g., when viewed along the main axis 228) or vice versa, and the percentage can be about 20%, about 30%, about 40%, about 50%, about 60%, about 70%, about 75%, about 80%, about 85%, about 90%, about 95%, about 98%, or about 100%, or any values or ranges between any of these values. In some implementations, the first suspension element 118 can extend laterally away from the central axis 228 by at least the same amount as the second suspension element 110. In some implementations, the second suspension element 110 can extend inward towards the central axis 228 by at least the same amount as the first suspension element 118. In embodiments (not shown in FIG. 2), inner suspension element 118 and outer suspension element 110 have a corrugated cross-section. In embodiments (not shown), inner suspension element 118 and outer suspension element 110 have different cross-sectional profiles.

Embodiments relate to loudspeaker transducer 100 comprising diaphragm 112, frame 120, and inner suspension element 118. Diaphragm 112 comprises a portion 102 turning inwards towards the frame 120. The inward turning portion 102 of the diaphragm 104 can extend downward from an upper portion of the diaphragm (e.g., the further portion 104). Inner suspension element 118 is connected to frame 120 and inward turning portion 102. Inner suspension element 118 is connected to inward turning portion 102 at an outer end 203 of diaphragm 112 (e.g., which can be a lower end of the diaphragm 112 and/or a lower end of the inward turning portion 102 of the diaphragm). In embodiments, inward turning portion 102 is connected at outer end 203 to inner suspension element 118 and is connected at an outer edge 205 (or ‘shoulder’) of diaphragm 112 to a further portion 104 of diaphragm 112 (e.g., which can be an upper portion of the diaphragm 112). Further portion 104 is attached at outer edge 205 to outer suspension element 110 and at an inner edge 207 (or ‘shoulder’) of diaphragm 112 to an inner portion 106 of diaphragm 112 (e.g., which can be radially inward of the further portion 104, closer to the main axis 228). In embodiments, diaphragm 112 comprises inner portion 106 and inner portion 106 comprises an inner end 201 of diaphragm 112. The laterally inner portion 106 of the diaphragm 112 can extend generally parallel to the central axis 228. The upper or further portion 104 of the diaphragm 112 can extend laterally or generally orthogonal to the central axis 228, between the radially inner portion 106 and the laterally outer portion 102 of the diaphragm 112. The laterally outer portion (e.g., or inward turning portion) 102 of the diaphragm 112 can extend generally parallel to the central axis 228. The upper or further portion 104 of the diaphragm 112 can extend between the upper ends of the laterally inner portion 106 and the laterally outer portion (or inward turning portion) 102 of the diaphragm 112.

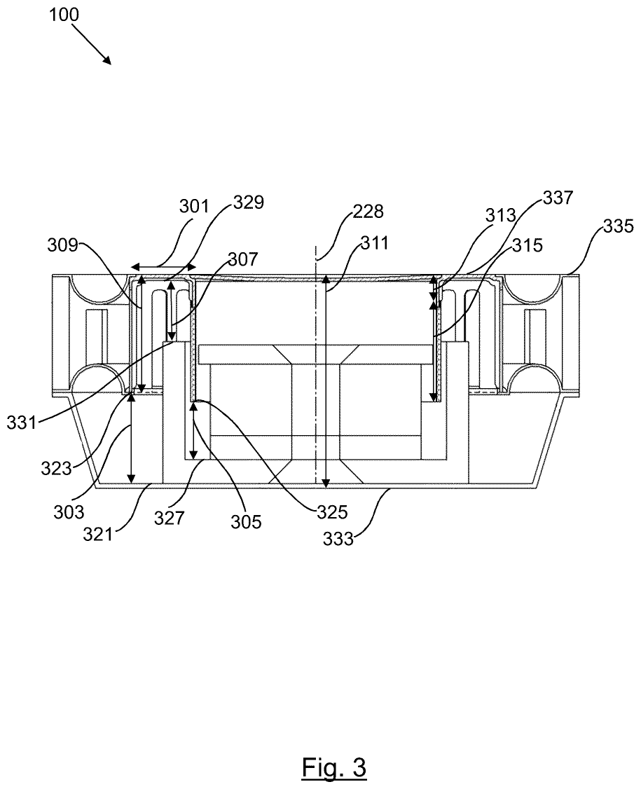

FIG. 3 shows loudspeaker transducer 100 from a cross-sectional side view. A first length 301 is the distance from outer edge 205 to inner edge 207 of diaphragm 112 in a direction substantially perpendicular to central axis 228.

A second length 303 is the distance between an upward facing internal surface 321 of frame 120 and outer end 203 of diaphragm 112 along the direction of central axis 228. The term upward facing is used here to refer to a direction along central axis 228 away from frame 120 and towards dust cap 114. Upward facing internal surface 321 of frame 120 is substantially perpendicular to central axis 228. The second length 303 can be a distance between the upward facing internal surface 321 of the frame 120 and the first suspension element 118.

A third length 305 is the distance between a lower end 325 of voice coil 126 and an internal surface 327 of magnet structure 124 along the direction of central axis 228. Internal surface 327 is substantially perpendicular to central axis 228. Lower end 325 of voice coil 126 is the end of voice coil 126 closest to frame 120 and furthest from dust cap 114 along the direction of central axis 228.

A fourth length 307 is the distance between a lower surface 329 of further portion 104 of diaphragm 112 and an upper surface 331 of magnet structure 124 along the direction of central axis 228. Lower surface 329 of further portion 104 is substantially perpendicular to central axis 228, in some implementations. Lower surface 329 of further portion 104 faces inwards towards upward facing internal surface 321 of frame 120. Upper surface 331 of magnet structure 124 is substantially perpendicular to central axis 228. Upper surface 331 of magnet structure 124 is the face of magnet structure 124 closest to further portion 104 along the direction of central axis 228.

Second length 303, third length 305, and fourth length 307 each have a minimum length greater than a given maximum diaphragm excursion height in order to avoid diaphragm 112 colliding with frame 120 or magnet structure 124 during use.

A depth 311 of loudspeaker transducer 100 is the distance between an outer surface 333 of frame 120 and a top surface 335 of frame 120.

Length 313 of the laterally inner portion 106 of the diaphragm 112 is the distance between the top end of voice coil 126 and inner edge 207 of diaphragm 112.

Connecting the first or inner suspension element 118 to inward turning portion 102 at outer end 203 of diaphragm 112 allows inner suspension element 118 to be positioned such that it is not above magnet structure 124 of loudspeaker transducer 100 (where ‘above’ is with respect to central axis 228 of magnet structure 124). Because inner suspension element 118 is positioned such that it is not above magnet structure 124, second length 303 can overlap with the depth of magnet structure 124 rather than being in addition to the magnet structure height, and depth 311 of loudspeaker transducer 100 can thus be reduced without compromising on the quality of sound produced. This allows loudspeaker transducer 100 to be of smaller depth 311 than a typical loudspeaker transducer for the same frequency range at a particular desired acoustic output level and allows loudspeaker transducer 100 to be fitted into smaller speaker enclosures such as those used in sound bars. Inner suspension element 118 acts to reduce rocking motions in diaphragm 112 that would create distortion and damage loudspeaker transducer 100. Inward turning portion 102 of diaphragm 112 allows inner suspension element 118 to be attached to diaphragm 112 at a location that provides stability against rocking motions. As can be seen in FIGS. 2 and 3, the first suspension element 118 can be disposed laterally outward of the magnet structure 124. The second suspension element 110 can be disposed laterally outward of the magnet structure 124. The first suspension element 118 can be disposed longitudinally next to the magnet structure 124. As can be seen in FIGS. 2 and 3, the first suspension element 118 and the second suspension element 110 can both be disposed laterally outward of the diaphragm 112. A footprint of the first suspension element 118 can be disposed entirely outside of a footprint of the magnet structure 124, when viewed along the direction of the main axis. A footprint of the second suspension element 110 can be disposed entirely outside of a footprint of the magnet structure 124, when viewed along the direction of the main axis.

In embodiments, a length 309 of inward turning portion 102 is dependent upon a desired excursion parameter of loudspeaker transducer 100. Second length 303 has a minimum length greater than a depth required to avoid a collision when diaphragm 112 is at maximum excursion. Depth 311 of loudspeaker transducer 100 is determined by second length 303 and length 309 of inward turning portion 102.

In embodiments, a length of inward turning portion 102 is dependent upon desired depth 311 of loudspeaker transducer 100. Third length 305 has a minimum length greater than the depth required to avoid a collision when diaphragm 112 is at a maximum excursion.

In embodiments, diaphragm 112 comprises further portion 104 substantially parallel to top surface 116 of magnet structure 124. Further portion 104 of diaphragm 112 acts to extend diaphragm 112 out to a greater distance from central axis 228 of magnet structure 124. This makes it possible for inward turning portion 102 of diaphragm 112 to wrap around magnet structure 124. This allows second length 303 (second length 303 is greater than the maximum excursion height of diaphragm 112) to overlap with the height of magnet structure 124. Therefore, depth 311 of loudspeaker transducer 100 can be reduced without compromising on the quality of sound produced.

In embodiments, top surface 116 of magnet structure 124 is substantially parallel to further portion 104 of diaphragm 112. In embodiments, inward turning portion 102 is connected to further portion 104 at an outer edge of further portion 104.

In embodiments, inner portion 106 turns inwards towards frame 120. Inner portion 106 provides a convenient location for voice coil 126 to be bonded to diaphragm 112, which improves the case of attaching voice coil 126 to diaphragm 112. Inner portion 106 allows voice coil 126 to be positioned in an efficient location in relation to magnet structure 124.

In embodiments, inner portion 106 is substantially parallel to inward turning portion 102. This allows diaphragm 112 to be fitted more tightly around magnet structure 124. This also allows diaphragm 112 to perform a maximum excursion without colliding with magnet structure 124.

In embodiments, inward turning portion 102 is substantially perpendicular to further portion 104. This allows diaphragm 112 to be fitted more tightly around magnet structure 124 while still allowing diaphragm 112 to achieve the maximum excursion during use without collision.

In embodiments, loudspeaker transducer 100 comprises voice coil 126 and voice coil 126 is not connected to inner suspension element 118. Hence, inner suspension element 118 is not adjacent to magnet structure 124 as a spider would be in a typical loudspeaker transducer. Thus, the need for space between magnet structure 124 and inner suspension element 118 along central axis 228 of magnet structure 124 is reduced. This means that second length 303 (second length 303 is greater than the depth required for maximum excursion of diaphragm 112) can overlap with the height of magnet structure 124. Therefore, depth 311 of loudspeaker transducer 100 can be reduced without compromising on the quality of sound produced.

In embodiments, voice coil 126 is connected to inner end 201 of diaphragm 112. Thus, voice coil 126 is aligned centrally around central axis 228 of magnet structure 124 which allows magnet structure 124 and voice coil 126 (which together are commonly referred to as the ‘motor’) to provide a more uniform force across diaphragm 112 which helps avoid distortion in the sound waves produced by loudspeaker transducer 100.

In embodiments, when loudspeaker transducer 100 is not in use, voice coil 126 rests in a neutral position so that it is centred around magnet structure 124 and is partially within magnet structure 124. In embodiments, loudspeaker transducer 100 comprises outer suspension element 110 connected to frame 120 and diaphragm 112. Outer suspension element 110 increases the stability of diaphragm 112 and further reduces unwanted rocking motion or vibration in directions that could reduce the sound quality produced by loudspeaker transducer 100.

In embodiments, frame 120 has openings to allow air to pass more freely into the internal regions of loudspeaker transducer 100, which avoids large ‘push-pull’ pressure changes within the loudspeaker transducer during use. In embodiments, frame 120 has holes to allow air to pass more freely into and out of the internal regions of loudspeaker transducer 100, which helps avoid large pressure changes within the loudspeaker transducer during use.

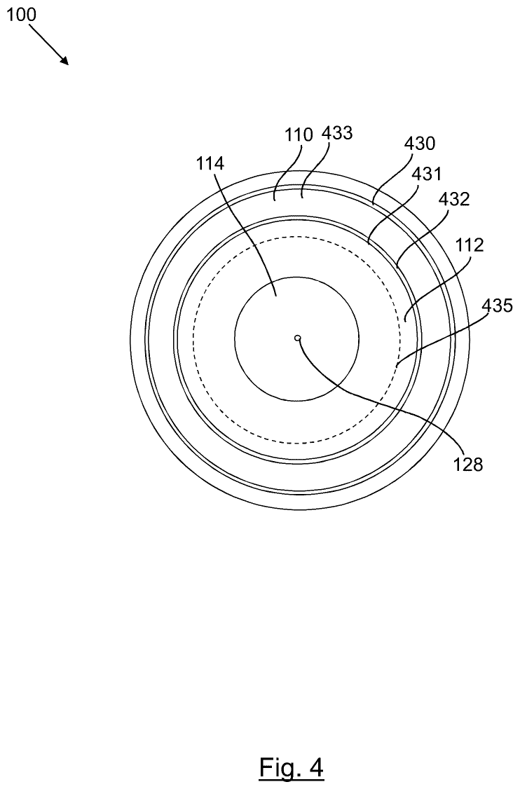

FIG. 4 shows a plan view of loudspeaker transducer 100 according to embodiments of the present disclosure. In embodiments, loudspeaker transducer 100 is circular in shape and has central axis 228. Outer suspension element 110 is attached at an outer edge 430 to frame 120 and at an inner edge 432 to diaphragm 112. Outer suspension element 110 has an annular shape in plan view. Outer suspension element 110 is centred on central axis 228. Dust cap 114 has a circular shape in plan view and is centred on central axis 228. Dust cap 114 is attached at its circular outer edge to diaphragm 112. In embodiments, dust cap 114 and diaphragm 112 comprise one piece rather than two separate components.

In embodiments, magnet structure 124 is attached to frame 120. In embodiments, loudspeaker transducer 100 comprises magnet structure 124, wherein inward turning portion 102 overlaps outside a perimeter 435 of magnet structure 124 with at least part of the height of magnet structure 124. Thus, magnet structure 124, diaphragm 112 and inner suspension element 118 can occupy the same cross-sectional plane (where the cross-sectional plane is substantially parallel to a top surface 116 of magnet structure 124). Wrapping diaphragm 112 around magnet structure 124 in this way reduces the need for space between magnet structure 124 and inner suspension element 118. This means that loudspeaker transducer 100 can have reduced depth 311 compared to what would otherwise be required, without sacrificing on space for the excursion needed to generate adequate low-frequency output.

In embodiments, outer suspension element 110 is connected to an outer edge 431 of further portion 104 of diaphragm 112. Inward turning portion 102 of diaphragm 112 has a length 309 large enough to allow inner suspension element 118 to be attached to diaphragm 112 at a distance from where outer suspension element 110 is attached that provides stability against rocking motions. In some embodiments, outer suspension element 110 comprises an unbroken surface 433 that is continuously connected to frame 120 and diaphragm 112. Hence, outer suspension element 110 acts to block dust and other debris from entering loudspeaker transducer 100. In other embodiments, inner suspension element 118 comprises a surface with at least one perforation. Hence, air is allowed to pass through inner suspension element 118. Thus, air can pass more freely into and out of the internal regions of loudspeaker transducer 100, which helps reduce pressure changes within the loudspeaker transducer during use.

In some embodiments, inner suspension element 118 is continuously connected to inward turning portion 102 along an entire outer end 203 of diaphragm 112. Continuously connecting inner suspension element 118 to inward turning portion 102 along an outer end 203 of diaphragm 112 provides uniform stability to diaphragm 112. In other embodiments, inner suspension element 118 is discontinuously connected to inward turning portion 102 at one or more parts of outer end 203 of diaphragm 112. Hence, less material is required to make inner suspension element 118. Further, air can pass through inner suspension element 118. Thus, air can pass more freely into and out of the internal regions of loudspeaker transducer 100 which helps reduce pressure changes within loudspeaker transducer 100 during use.

In embodiments, outer suspension element 110 is attached at inner edge 432 to further portion 104 of diaphragm 112 and at outer edge 430 to frame 120. Dust cap 114 is attached to diaphragm 112 centrally within loudspeaker transducer 100.

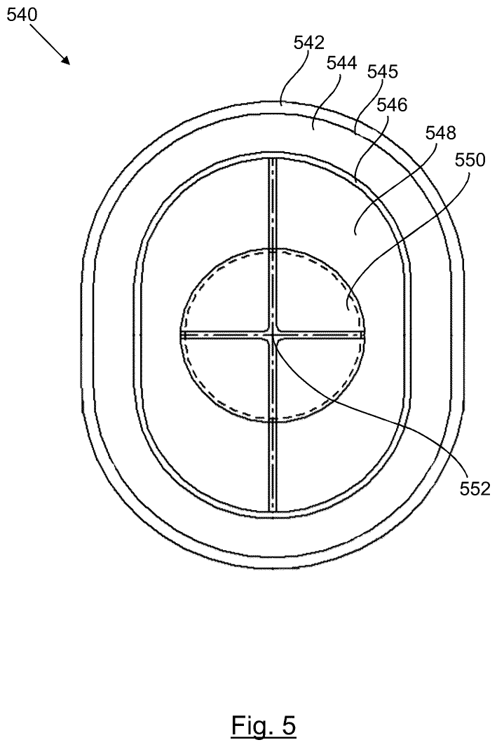

FIG. 5 shows a plan view of a lozenge shaped loudspeaker transducer 540 according to embodiments of the disclosure. In embodiments, loudspeaker transducer 540 comprises a frame 542, an outer suspension element 544, a diaphragm 548, and a dust cap 550. A central axis 552 runs through the centre of loudspeaker transducer 540. Dust cap 550 is circular and is centred on central axis 552. Outer suspension element 544 has an inner edge 546 which is a lozenge shape when viewed in plan view. Outer suspension element 544 has an outer edge 545 which is a lozenge shape when viewed in plan view and which is larger than inner edge 546. Inner edge 546 and outer edge 545 are both centred on central axis 552. Frame 542 is attached to outer edge 545 of outer suspension element 544 and is centred on central axis 552. In embodiments including lozenge shaped loudspeaker transducer 540, diaphragm 548 comprises a portion turning inwards towards the frame.

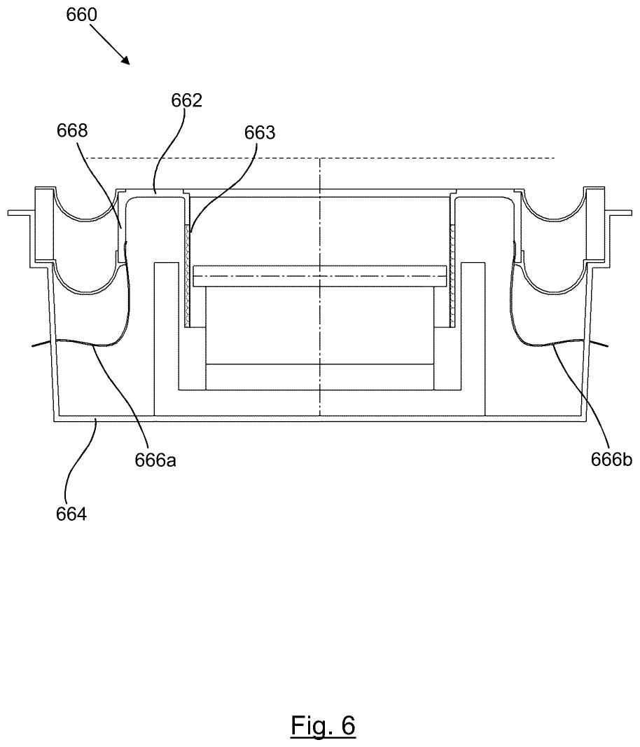

FIG. 6 shows a cross-section side view of a loudspeaker transducer 660 according to embodiments of the present disclosure. In embodiments, loudspeaker transducer 660 comprises a frame 664, a diaphragm 662, a voice coil 663, a first wire connection 666a and a second wire connection 666b. First wire connection 666a passes through a hole in frame 664 and attaches to an inward turning portion 668 of diaphragm 662. First wire connection 666a is threaded through diaphragm 662 to reach voice coil 663. Second wire connection 666b passes from voice coil 663, through diaphragm 662, and out through a hole in frame 664. First wire connection 666a and second wire connection 666b allow loudspeaker transducer 660 to be supplied with electrical input.

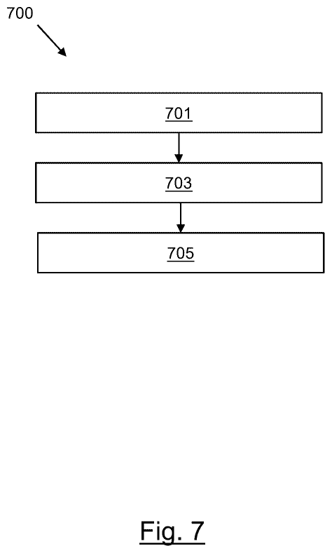

FIG. 7 shows a method 700 of manufacturing a loudspeaker transducer according to embodiments of the present disclosure. Embodiments comprise a method of manufacturing a loudspeaker transducer comprising a diaphragm, a frame, an inner suspension element and an outer suspensions element, the method comprising forming 701 the diaphragm with a portion turning inwards towards the frame, attaching 703 the inner suspension element to the frame and attaching 705 the inner suspension element to the inward turning portion at an outer end of the diaphragm. The inner suspension element is attached to the frame and the diaphragm such that it is further away than the outer suspension element to the main opening of the frame through which the loudspeaker transducer radiates sound.

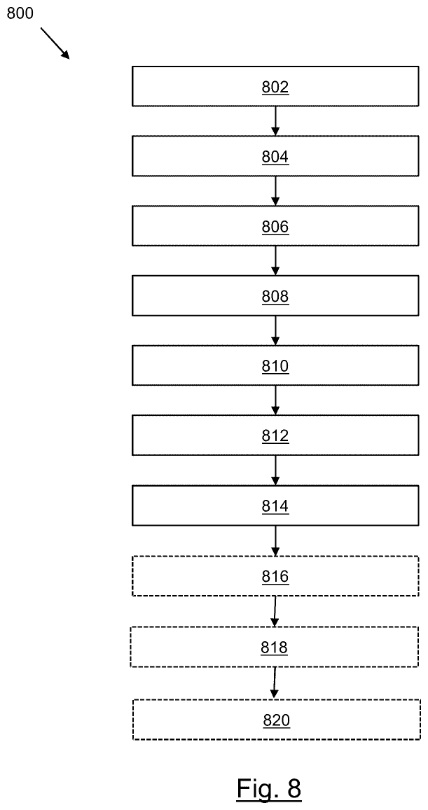

FIG. 8 shows a method 800 of manufacturing a loudspeaker transducer according to embodiments of the present disclosure. Embodiments comprise a method of manufacturing a loudspeaker transducer comprising: forming 802 a diaphragm; forming 804 a first frame part; forming 806 a suspension element; forming 808 a second frame part; attaching 810 a suspension element to the first frame part; attaching 812 the diaphragm to the suspension element. The diaphragm comprises an inward turning portion which turns inwards towards the first frame part and the suspension element attaches to the inward turning portion at an outer end of the diaphragm. The method comprises attaching 814 the second frame part to the first frame part. Forming the loudspeaker transducer from a first frame part and a second frame part allows the loudspeaker transducer to be manufactured and assembled more easily than with a single frame. In embodiments, the method comprises forming 816 a further suspension element; attaching 818 the further suspension element to the second frame part; and attaching 820 the further suspension element to the diaphragm.

Embodiments comprise a method of assembling a loudspeaker transducer comprising: attaching a suspension element to a first frame part; attaching a diaphragm to the suspension element, wherein the diaphragm comprises an inward turning portion which turns inwards towards the first frame part; and attaching a second frame part to the first frame part. In embodiments, the method of assembling a loudspeaker transducer comprises attaching a further suspension element to the second frame part and attaching the further suspension element to the diaphragm.

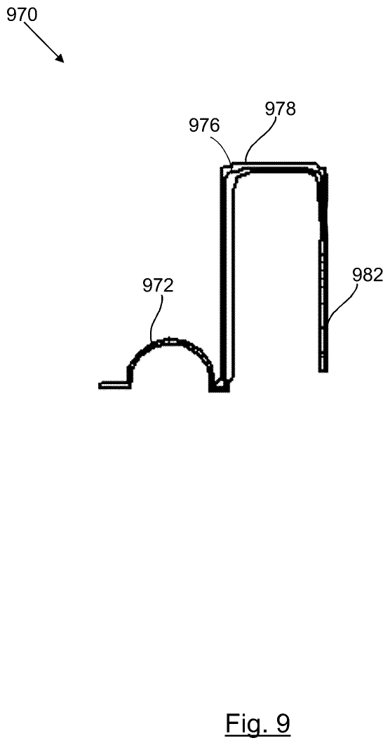

FIG. 9 shows a cross-sectional side view of components 970 of a loudspeaker transducer according to embodiments of the present disclosure. Components 970 comprise a suspension element 972, a diaphragm 978, a voice coil 982 and a wire connection 976. Wire connection 976 passes through a channel in suspension element 972, and passes through a channel in diaphragm 978 in order to connect to voice coil 982.

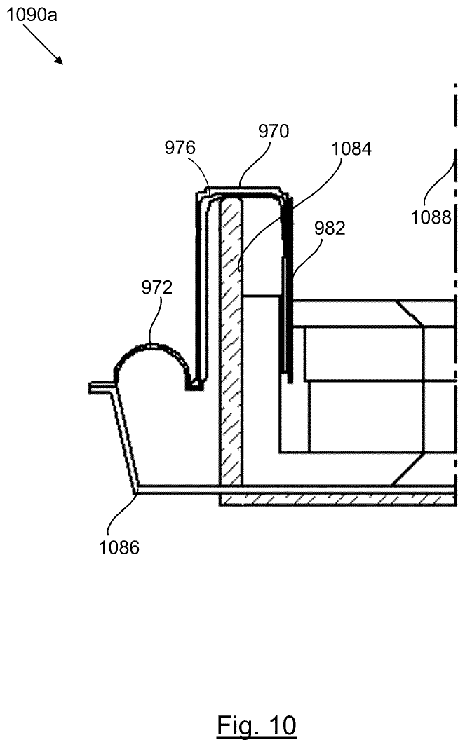

FIG. 10 shows a cross-sectional side view of components 1090a of a loudspeaker transducer during assembly according to embodiments of the present disclosure. Components 1090a comprise suspension element 972, diaphragm 978, voice coil 982 and wire connection 976 and also include a first frame part 1086 and a support element 1084. A central axis 1088 runs through the centre of the loudspeaker transducer. FIG. 10 shows the loudspeaker transducer during manufacturing once the method steps of attaching suspension element 972 to first frame part 1086 (corresponding to 810 in FIG. 8) and attaching diaphragm 978 to suspension element 972 (corresponding to 812 in FIG. 8) have been carried out.

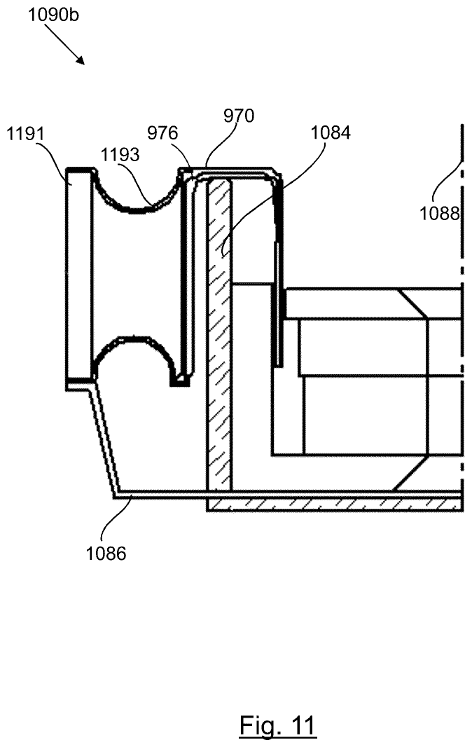

FIG. 11 shows a cross-sectional side view of components 1090b, including components 1090a shown in FIG. 10, a second frame part 1191 and a further suspension element 1193. FIG. 11 shows the loudspeaker transducer during manufacturing once the method steps of attaching second frame part 1191 to first frame part 1086 (corresponding to 814 in FIG. 8), attaching further suspension element 1193 to second frame part 1191 (corresponding to 818 in FIG. 8), and attaching further suspension element 1193 to diaphragm 978 (corresponding to 820 in FIG. 8) have been carried out.

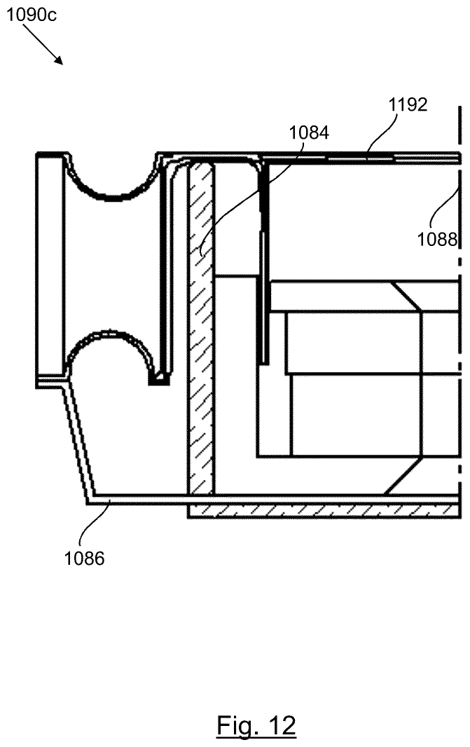

FIG. 12 shows a cross-sectional side view of components 1090c, including components 1090b shown in FIG. 11 and a dust cap 1192. FIG. 12 shows the loudspeaker transducer during manufacturing once the step of attaching dust cap 1192 to diaphragm 978 has been carried out.

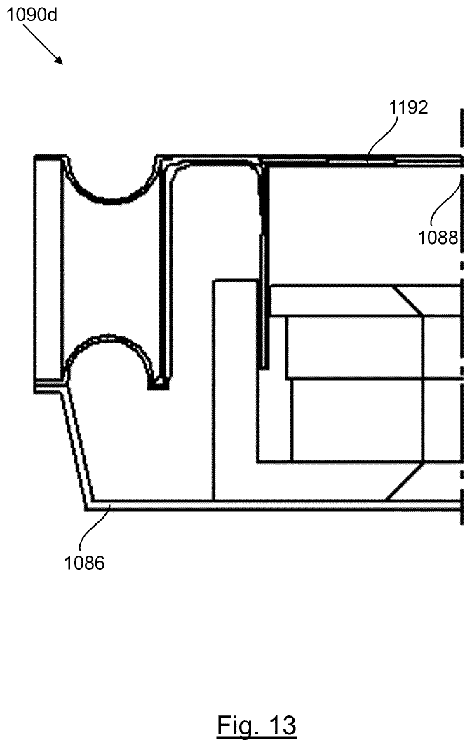

FIG. 13 shows a cross-sectional side view of components 1090d, including components 1090c shown in FIG. 12 but with support element 1084 removed. Support element 1084 is an additional element which is used temporarily during the manufacturing/assembly process to facilitate more efficient manufacture/assembly. FIG. 13 shows the loudspeaker transducer once manufacturing/assembly has been completed.

Whilst the present disclosure has been described and illustrated with reference to particular embodiments, it will be appreciated by those of ordinary skill in the art that the present disclosure lends itself to many different variations not specifically illustrated herein. By way of example only, certain possible variations will now be described.

In embodiments, suspension element 972 comprises an inner suspension element (for example inner suspension element 118) and further suspension element 1193 comprises an outer suspension element (for example outer suspension element 110), where the outer suspension element is located closer than the inner suspension element to the main opening of the frame through which the loudspeaker transducer radiates sound.

In alternative embodiments, loudspeaker transducer 100 comprises a rounded shape. In other embodiments, loudspeaker transducer 100 comprises a square shape.

In alternative embodiments, loudspeaker transducer 100 comprises one or more of an ovular shape, an elliptical shape, and a rectangular shape.

In some embodiments, the diaphragm has an inward turning portion that is curved. In other embodiments, the diaphragm has an inward turning portion that is diagonal in relation to a central axis of the loudspeaker transducer.

In embodiments, the diaphragm has one or more holes which reduce the mass of the diaphragm. In embodiments, the diaphragm has one or more cut-outs which reduce the mass of the diaphragm. In embodiments, the dust cap has one or more holes which reduce the mass of the dust cap.

In embodiments, the diaphragm is ribbed. The ribs provide increased stiffness to the diaphragm. In embodiments, the diaphragm has one or more bracing elements. The bracing elements provide increased stiffness to the diaphragm.

In embodiments, suspension elements 118 and/or 110 are flexible enough to have a desired resonant frequency, and stiff enough to provide stability to the diaphragm.

In embodiments, suspension elements 118 and/or 110 are made from rubber, this allows the suspension elements to be flexible enough to have a required resonant frequency and to be stiff enough to provide stability to the diaphragm.

In embodiments, the diaphragm and dust cap are molded from plastic. In embodiments, the diaphragm and dust cap are cast from metal. In embodiments, the diaphragm and dust cap are cast from aluminum. In embodiments, the diaphragm and dust cap are machined out of a block of material.

In embodiments, a suspension element is connected at any location on the outer surface of the diaphragm.

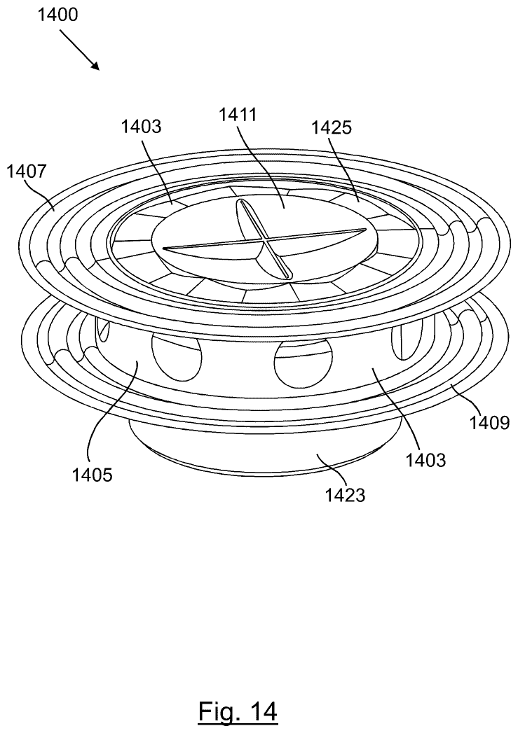

FIG. 14 shows a perspective view of portions of a loudspeaker transducer 1400 according to embodiments of the present disclosure. Some components (e.g., the frame) are omitted from view in FIG. 14, to facilitate illustrations of the components discussed. Loudspeaker transducer 1400 comprises a magnet structure 1423, a first suspension element (e.g., an inner suspension element 1409), a second suspension element (e.g., an outer suspension element 1407), a dust cap 1411 and a diaphragm 1403. Diaphragm 1403 comprises an inward turning portion 1405. Diaphragm 1403 comprises a further portion 1425.

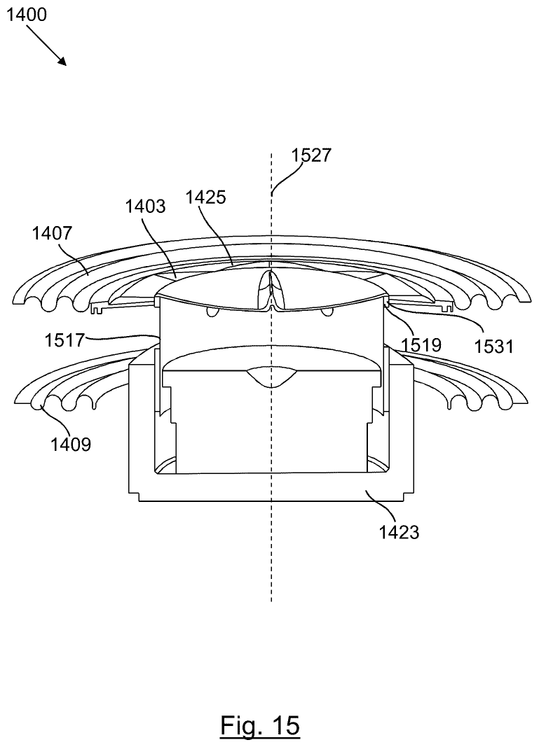

FIG. 15 shows the portions of loudspeaker transducer 1400 of FIG. 14 from a cross-sectional perspective view. Magnet structure 1423 is positioned centrally within loudspeaker transducer 1400. Loudspeaker transducer 1400 comprises a voice coil 1517. A central axis 1527 of magnet structure 1423 is represented as a dashed line in FIG. 15. Diaphragm 1403 is arranged such that it is centred on central axis 1527 and attached to voice coil 1517 such that voice coil 1517 is centred on central axis 1527. In embodiments, voice coil 1517 is attached to further portion 1425 of diaphragm 1403 at an inner edge 1519 of further portion 1425. In embodiments, further portion 1425 of diaphragm 1403 comprises an annulus. In embodiments, diaphragm 1403 comprises an inner portion 1531 which is located on inner edge 1519 of further portion 1425. In embodiments, voice coil 1517 is attached to inner portion 1531 of diaphragm 1403.

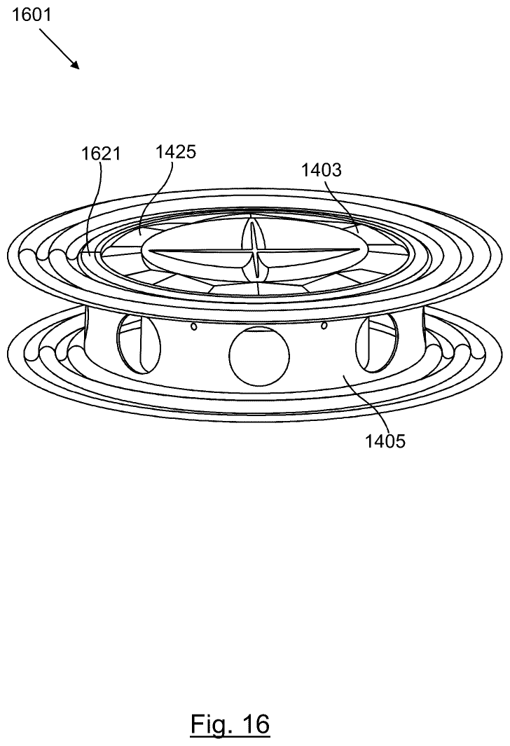

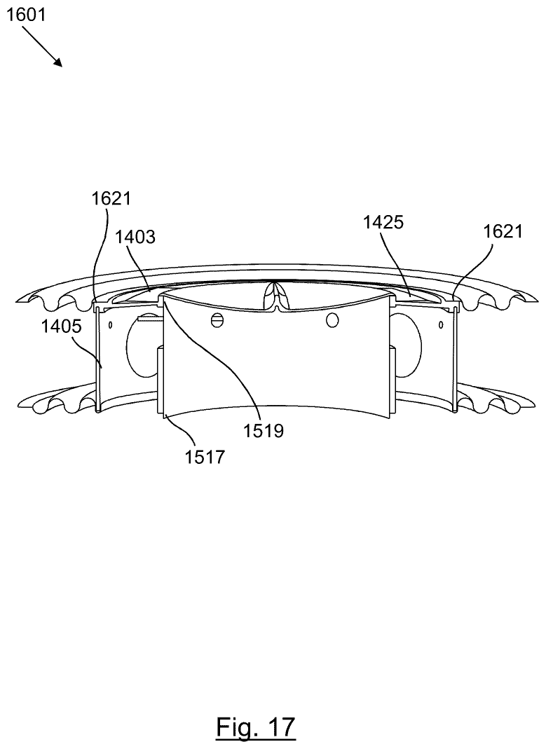

FIG. 16 shows a perspective view of components 1601 of loudspeaker transducer 1400 of FIG. 14. FIG. 17 shows a cross-sectional perspective view of components 1601 of FIG. 16. In embodiments, further portion 1425 of diaphragm 1403 is detachably connected to inward turning portion 1405 of diaphragm 1403 at an outer shoulder 1621 of diaphragm 1403. This allows inward turning portion 1405 of diaphragm 1403 to be attached to further portion 1425 of diaphragm 1403 during the manufacturing process of loudspeaker transducer 1400. Having such a two-part diaphragm simplifies the manufacturing process and improves the process of constructing loudspeaker transducer 1400.

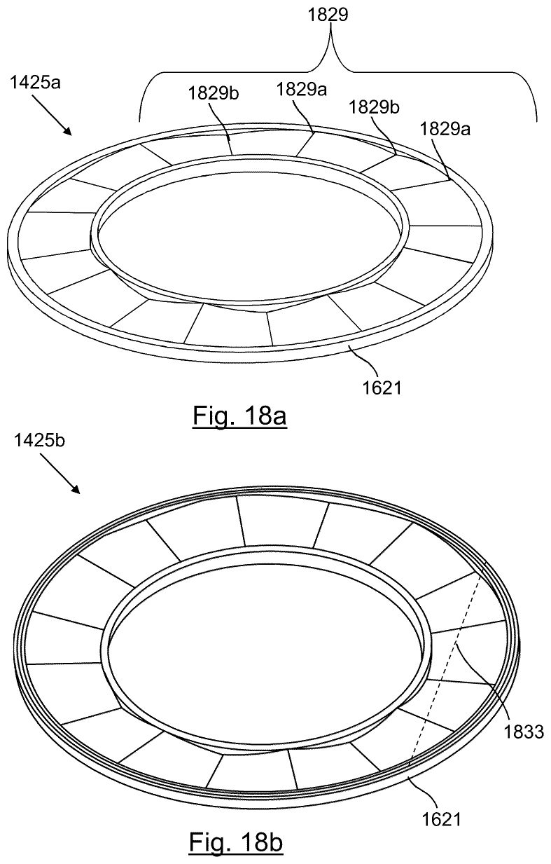

FIG. 18a shows a perspective view of further diaphragm portion 1425 from above (indicated by reference numeral 1425a) and FIG. 18b shows a perspective view of further diaphragm portion 1425 from below (indicated by reference numeral 1425b). In embodiments, further portion 1425 of diaphragm 1403 comprises one or more corrugations 1829. In embodiments, at least one of the one or more corrugations 1829 is v-shaped. The v-shape(s) is/are visible in one or more cross-sectional planes (e.g. those that are substantially perpendicular to further portion 1425) defined by a chord of further portion 1425, where both endpoints of the chord are located on shoulder 1621 of diaphragm 1403. Dashed line 1833 in FIG. 18b shows an example chord, which defines a cross-sectional plane in which v-shaped corrugations 1829 are visible. Some example corrugations 1829 are indicated in FIGS. 18a and 18b with reference numeral 1829a indicating corrugation peaks and reference numeral 1829b indicating corrugation troughs. In embodiments, at least one of the one or more corrugations 1829 is rounded (or ‘wavy’). In embodiments, further portion 1425 of diaphragm 1403 comprises irregular or non-uniform corrugations 1829. Corrugations 1829 in further portion 1425 provide increased stiffness to diaphragm 1403.

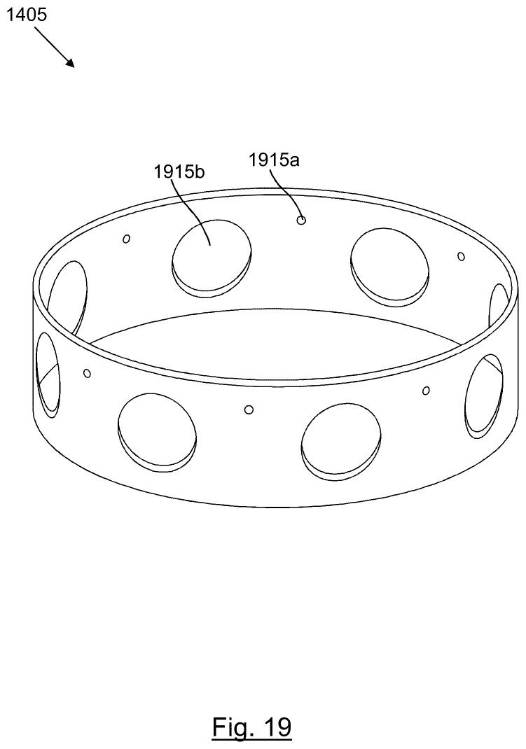

FIG. 19 shows a perspective view of inward turning portion 1405 of diaphragm 1403. In embodiments, inward turning portion 1405 comprises a cylindrical hollow tube. In embodiments, inward turning portion 1405 comprises one or more holes 1915. Holes 1915 allow the weight of inward turning portion 1405 to be reduced and allow wires and other components to pass from one side of inward turning portion 1405 to another. In embodiments, inward turning portion 1405 comprises a first set of holes 1915a and a second set of holes 1915b, second set of holes 115b being larger than first set of holes 1915a.

In embodiments, first set of holes 1915a and second set of holes 1915b are circular. In embodiments, second set of holes 1915b has a larger radius than first set of holes 1915a, making second set of holes 1915b larger in terms of area. In embodiments, first set of holes 1915a and second set of holes 1915b are non-circular. In embodiments, second set of holes 1915b has a greater area per hole than first set of holes 1915a. In embodiments, first set of holes 1915a comprise an equal number of holes as second set of holes 1915b. In embodiments, first set of holes 1915a are spaced uniformly around a circumference of inward turning portion 1405. In embodiments, second set of holes 1915b are spaced uniformly around a circumference of inward turning portion 1405. In embodiments, first set of holes 1915a and second set of holes 1915b are spaced around inward turning portion 1405 such that each hole of first set of holes 1915a is located between two holes of second set of holes 1915b. In embodiments, inward turning portion 1405 of diaphragm 1403 comprises rolled paper. In embodiments, inward turning portion 1405 of diaphragm 1403 comprises extruded plastic. In embodiments, inward turning portion 1405 of diaphragm 1403 comprises formed aluminium.

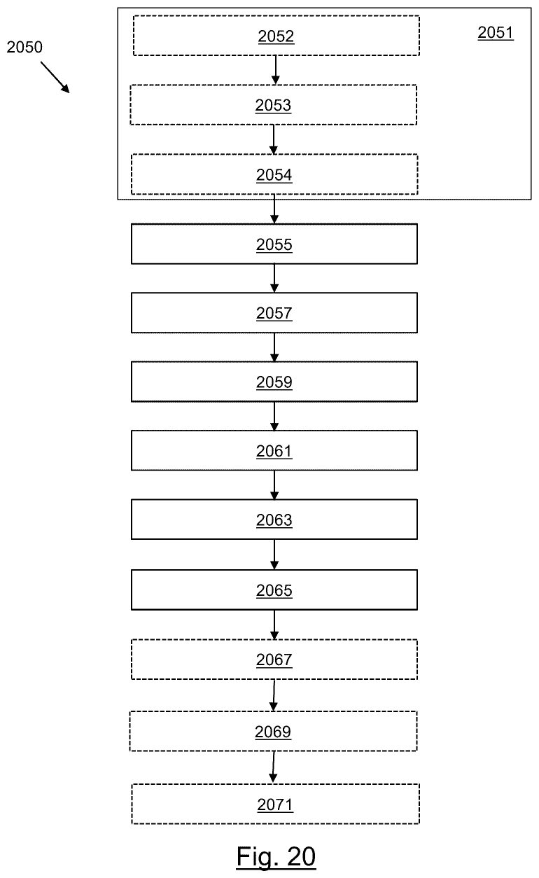

FIG. 20 shows a method 2050 of manufacturing a loudspeaker transducer according to embodiments of the present disclosure. Embodiments comprise a method of manufacturing a loudspeaker transducer comprising: forming 2051 a diaphragm; forming 2055 a first frame part; forming 2057 a suspension element; forming 2059 a second frame part; attaching 2061 a suspension element to the first frame part; attaching 2063 the diaphragm to the suspension element. The diaphragm comprises an inward turning portion which turns inwards towards the first frame part and the suspension element attaches to the inward turning portion at an outer end of the diaphragm. In embodiments, the step of forming 2051 the diaphragm comprises: forming 2052 a further portion; forming 2053 an inward turning portion; and attaching 2054 the further portion to the inward turning portion. Forming the diaphragm from two separate parts allows the diaphragm to be manufactured and assembled more easily than with a single diaphragm. The method comprises attaching 2065 the second frame part to the first frame part. Forming the loudspeaker transducer from a first frame part and a second frame part allows the loudspeaker transducer to be manufactured and assembled more easily than with a single frame. In embodiments, the method comprises forming 2067 a further suspension element; attaching 2069 the further suspension element to the second frame part; and attaching 2071 the further suspension element to the diaphragm.

In some embodiments, the further portion 104 can be considered the diaphragm 112, and the inner portion 106 can be an inner coupler that couples the diaphragm 112 (e.g., an inner edge or portion thereof) to the voice coil 126. The downturned portion 102 can be an outer coupler, which can extend (e.g., generally rearward) from the diaphragm 112 (e.g., from an outer edge or portion thereof). A first suspension element 118 can extend from the outer coupler 102 (e.g., from a rearward edge or portion thereof) to the frame 120. A second suspension element 110 can extend from the diaphragm 112 (e.g., from the outer edge or portion thereof) to the frame 120. The inner coupler 106 can extend substantially parallel to a longitudinal axis 228 of the transducer 100. The outer coupler 102 can extend substantially parallel to a longitudinal axis 228 of the transducer 100.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the present disclosure that are described as preferable, advantageous, convenient or the like are optional and do not limit the scope of the independent claims. Moreover, it is to be understood that such optional integers or features, whilst of possible benefit in some embodiments of the present disclosure, may not be desirable, and may therefore be absent, in other embodiments.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, this disclosure covers all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example+5%, +10%, +15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

1. A loudspeaker transducer comprising a diaphragm, a frame, an inner suspension element and an outer suspension element, wherein:
the diaphragm comprises a portion turning inwards towards the frame,
the outer suspension element is located closer than the inner suspension element to the main opening of the frame through which the loudspeaker transducer radiates sound,
the inner suspension element is connected to the frame and the inward turning portion, and
the inner suspension element is connected to the inward turning portion at an outer end of the diaphragm.

2. The loudspeaker transducer of claim 1, wherein a length of the inward turning portion is dependent upon a desired excursion parameter of the loudspeaker transducer.

3. The loudspeaker transducer of claim 1, wherein a length of the inward turning portion is dependent upon a desired depth of the loudspeaker transducer.

4. The loudspeaker transducer of claim 1, wherein the inner suspension element is continuously connected to the inward turning portion along an entire outer end of the diaphragm.

5. The loudspeaker transducer of claim 1, wherein the inner suspension element is discontinuously connected to the inward turning portion at one or more parts of an outer end of the diaphragm.

6. The loudspeaker transducer of claim 1, comprising a voice coil, wherein the voice coil is not connected to the inner suspension element.

7. The loudspeaker transducer of claim 1, comprising a voice coil, wherein the voice coil is connected to an inner end of the diaphragm.

8. The loudspeaker transducer of claim 1, wherein:
the diaphragm comprises an inner portion, and
the inner portion comprises an inner end of the diaphragm.

9. The loudspeaker transducer of claim 8, wherein the inner portion turns inwards towards the frame.

10. The loudspeaker transducer of claim 8, wherein the inner portion is substantially parallel to the inward turning portion.

11. The loudspeaker transducer of claim 1, comprising a magnet structure, wherein the inward turning portion overlaps outside a perimeter of the magnet structure with at least part of the height of the magnet structure.

12. The loudspeaker transducer of claim 1, wherein the diaphragm comprises a further portion.

13. The loudspeaker transducer of claim 12, comprising a magnet structure, wherein the further portion is substantially parallel to a top surface of the magnet structure.

14. The loudspeaker transducer of claim 12, wherein the inward turning portion is substantially perpendicular to the further portion.

15. The loudspeaker transducer of claim 12, wherein the inward turning portion is connected to the further portion at an outer edge of the diaphragm.

16. The loudspeaker transducer of claim 1, wherein the outer suspension element is connected to the frame and the diaphragm.

17. The loudspeaker transducer of claim 12, wherein the outer suspension element is connected to the frame and the diaphragm, and the outer suspension element is connected to an outer edge of the further portion of the diaphragm.

18. The loudspeaker transducer of claim 1, wherein the inner suspension element comprises a surface with at least one perforation.

19. The loudspeaker transducer of claim 12, wherein the further portion comprises an annulus.

20. The loudspeaker transducer of claim 12, wherein the further portion comprises one or more corrugations.

21. The loudspeaker transducer of claim 20, wherein at least one of the one or more corrugations is v-shaped.

22. The loudspeaker transducer of claim 12, wherein the further portion of the diaphragm is detachably connected to the inward turning portion of the diaphragm at a shoulder of the diaphragm.

23. The loudspeaker transducer of claim 1, wherein the inward turning portion comprises a cylindrical hollow tube.

24. The loudspeaker transducer of claim 1, wherein the inward turning portion comprises one or more holes.

25. The loudspeaker transducer of claim 1, wherein the inward turning portion comprises a first set of holes and a second set of holes, the second set of holes being larger than the first set of holes.

26. A method of manufacturing a loudspeaker transducer comprising a diaphragm, a frame, an inner suspension element and an outer suspension element, the method comprising:
forming the diaphragm with a portion turning inwards towards the frame; and
attaching the inner suspension element to the frame and the inward turning portion at an outer end of the diaphragm, wherein the inner suspension element is attached to the frame and the diaphragm such that it is further away than the outer suspension element to the main opening of the frame through which the loudspeaker transducer radiates sound.

27. A method of manufacturing a loudspeaker transducer, the method comprising:
forming a diaphragm;
forming a first frame part;
forming a suspension element;
forming a second frame part;
attaching a suspension element to the first frame part;
attaching the diaphragm to the suspension element, wherein the diaphragm comprises an inward turning portion which turns inwards towards the first frame part and the suspension element attaches to the inward turning portion at an outer end of the diaphragm; and
attaching the second frame part to the first frame part.

28. The method of claim 27, wherein the step of forming a diaphragm comprises:
forming a further portion;
forming the inward turning portion; and
attaching the further portion to the inward turning portion.

29. The method of claim 27, the method comprising:
forming a further suspension element;
attaching the further suspension element to the second frame part; and
attaching the further suspension element to the diaphragm.

30. A loudspeaker transducer comprising:
a frame;
a magnet structure mounted to the frame;
a voice coil configured to operate with the magnet structure as a motor;
a diaphragm having an inner portion and an outer portion;
an inner coupler that couples the voice coil to the inner portion of the diaphragm;
an outer coupler that extends from an outer portion of the diaphragm;
a first suspension element coupled between the frame the outer coupler; and
a second suspension element coupled between the frame and the outer portion of the diaphragm.

31. The loudspeaker transducer of claim 30, wherein the inner coupler and the outer coupler are substantially parallel.

32. The loudspeaker transducer of claim 30, wherein the outer coupler extends rearward along a direction that is substantially parallel to a longitudinal axis of the transducer.

33. The loudspeaker transducer of claim 30, wherein the first suspension element is disposed directly rearward of the second suspension element.

34. The loudspeaker transducer of claim 30, wherein the first suspension element and the second suspension element are disposed laterally outward of the magnet structure.

35. The loudspeaker transducer of claim 30, wherein the first suspension element and the second suspension element are disposed laterally outward of the diaphragm.

36. The loudspeaker transducer of claim 30, wherein the outer coupler and the diaphragm are integrally formed.

37. The loudspeaker transducer of claim 30, wherein the outer coupler and the diaphragm are separately formed components.

38. The loudspeaker transducer of claim 30, wherein the diaphragm is generally perpendicular to a longitudinal axis of the loudspeaker transducer.

39. The loudspeaker transducer of claim 30, wherein the diaphragm comprises corrugations.

40. The loudspeaker transducer of claim 30, wherein the outer coupler includes holes.
